(19) United States
(12) Patent Application Publication
(10) Pub. No.: US 2018/0241208 A1
(43) Pub. Date: Aug. 23, 2018

(54) POWER TRANSMISSION ROUTE STATE DETECTION DEVICE, POWER TRANSMISSION ROUTE STATE DETECTION SYSTEM, POWER TRANSMISSION ROUTE STATE DETECTION METHOD, NON-TRANSITORY RECORDING MEDIUM AND POWER CONVERSION DEVICE

(71) Applicant: OMRON Corporation, KYOTO (JP)

(72) Inventors: Takayuki EDA, Tatebayashi-shi, GUNMA (JP); Kazuki KASAI, Setagaya-ku, TOKYO (JP); Hiroshi IMAI, Nara-shi, NARA (JP); Hiromasa TAKATSUKA, Ota-ku, TOKYO (JP); Fumiji AITA, Nara-shi, NARA (JP)

(73) Assignee: OMRON Corporation, KYOTO (JP)

(21) Appl. No.: 15/750,839

(22) PCT Filed: Nov. 17, 2016
(86) PCT No.: PCT/JP2016/084139

§ 371 Date: Feb. 7, 2018

(30) Foreign Application Priority Data
Feb. 25, 2016 (JP) 2016-034080

(51) Int. Cl. H02J 3/06; H02J 13/00; H02J 3/32; H02J 3/38; G06Q 50/06

(52) U.S. Cl. CPC H02J 3/06; H02J 13/00; G06Q 50/06; H02J 3/38; H02J 3/32

(57) ABSTRACT

This power transmission route state detection device (10) is provided with a power transmission route determination unit (13), a first power amount acquisition unit (11), a second power amount acquisition unit (12) and a state estimation unit (14). The power transmission route determination unit (13) determines a power transmission route for interchanging power between utility customers connected to a node (52) of a mesh-type power network (51). The first power amount acquisition unit (11) acquires the amount of power transmitted by an interchange-source utility customer (G20). The second power amount acquisition unit (12) acquires the amount of power transmitted to an interchange-destination utility customer (G30) from the interchange-source utility customer (G20). The state estimation unit (14) estimates the state of the determined power transmission route on the basis of amount of power acquired by the first power amount acquisition unit (11) and the second power amount acquisition unit (12).

### TECHNICAL FIELD

The present invention relates to a power transmission route state detection device, a power transmission route state detection system, a power transmission route state detection method, a power transmission route state detection program, and a power conversion device.

### BACKGROUND ART

In recent years, power generation apparatuses generating electric power using (for example, photovoltaic power generation apparatuses) renewable energy have been used. In Japan, since a surplus electric power purchase system is enacted, electric power generated by a photovoltaic power generation apparatus, a wind power generation apparatus, and the like can be sold to a power company.

In addition, a system that not only sells the generated power to a power company but also sells the power to unspecified consumers has been proposed (for example, see Patent Literature 1).

### CITATION LIST

### Patent Literature

### [Patent Literature 1]

Japanese Unexamined Patent Application Publication No. 2011-142771

### SUMMARY OF INVENTION

### Technical Problem

However, in Patent Literature 1, a case in which a defect is present in a power transmission route or a case in which power is stolen cannot be detected.

Particularly, in a case in which a mesh-type power network is formed, and electric power can be mutually circulated between consumers, a plurality of routes through which power can be transmitted are present, and it becomes more difficult to detect a defect of a power transmission route and power stealing between consumers.

An object of the present invention is to provide a power transmission route state detection device, a power transmission route state detection system, a power transmission route state detection method, a power transmission route state detection program, and a power conversion device capable of detecting a defect of a power transmission route or power stealing.

### Solution to Problem

A power transmission route state detection device according to the first invention includes a power transmission route acquiring unit, a first electric power acquiring unit, a second electric power acquiring unit, and a state estimating unit. The power transmission route acquiring unit acquires a power transmission route for executing circulation of electric power between consumers connected to nodes of a mesh-type power network. The first electric power acquiring unit acquires electric power transmitted by a consumer that is a circulation source. The second electric power acquiring unit acquires electric power transmitted to a consumer that is a circulation destination from the consumer that is the circulation source. The state estimating unit estimates a state of the power transmission route acquired by the power transmission route acquiring unit on the basis of the electric power acquired by the first electric power acquiring unit and the electric power acquired by the second electric power acquiring unit.

In this way, when electric power is circulated in a mesh-type power network, a power transmission route for transmitting electric power from a circulation source to a circulation destination is acquired. Then, the state of the power transmission route can be estimated on the basis of the electric power transmitted by the circulation source and the electric power received by the circulation destination.

For this reason, for example, in a case in which the electric power received by the circulation destination is lower than the electric power transmitted by the circulation source, the occurrence of a malfunction, power stealing, or the like in the acquired power transmission route can be detected.

A power transmission route state detection device according to the second invention is the power transmission route state detection device according to the first invention, in which the consumers are connected to nodes with which power distribution lines of the mesh-type power network intersect, and one or more of the nodes through which electric power passes at the time of power transmission are disposed between a node to which the consumer that is the circulation source is connected and a node to which the consumer that is the circulation destination is connected on the power transmission route. The second electric power acquiring unit acquires electric power of the node through which the electric power passes in addition to the node to which the consumer that is the circulation destination is connected.

In this way, the second electric power acquiring unit acquires electric power of at least one node on the power transmission route from the consumer that is the circulation source to the consumer that is the circulation destination. For this reason, the occurrence of a malfunction, power stealing, or the like between nodes of the power transmission route can be detected.

A power transmission route state detection device according to the third invention is the power transmission route state detection device according to the first invention, in which the first electric power acquiring unit acquires the electric power transmitted by the circulation source from a transmission unit of the consumer that is the circulation source through communication.

In this way, the first electric power acquiring unit can acquire the amount of power transmission transmitted by the consumer that is the circulation source through communication.

For example, the transmission unit is disposed in a power converting device (power conditioning device) of the consumer that is the circulation source, and this transmission unit and the first electric power acquiring unit can communicate with each other.

A power transmission route state detection device according to the fourth invention is the power transmission route state detection device according to the first invention and further includes an assumed power loss acquiring unit and a loss calculating unit. The assumed power loss acquiring unit acquires an assumed power loss between the node to which the consumer that is the circulation source is connected and the node to which the consumer that is the circulation destination is connected. The loss calculating unit calculates an actual power loss from a difference between the electric power acquired by the first electric power acquiring unit and the electric power. A determination unit determines whether or not the state of the power transmission route is normal by comparing the actual power loss calculated by the loss calculating unit with an assumed power loss amount acquired by the assumed power loss acquiring unit.

In this way, in a case in which the actual power loss amount is larger than the assumed power loss amount, the occurrence of a malfunction, power stealing, or the like in the power transmission route can be detected.

A power transmission route state detection device according to the fifth invention is the power transmission route state detection device according to the first invention, in which a detection unit detecting electric power is connected to a power distribution line drawn out from each of the nodes of the mesh-type power network. The second electric power acquiring unit acquires electric power of the node from the detection unit that is connected to a power distribution line drawn out from the node of the mesh-type power network.

In this way, the second electric power acquiring unit can acquire the electric power received by the consumer that is the circulation destination and can estimate the state of the power transmission route.

A power transmission route state detection device according to the sixth invention is the power transmission route state detection device according to the first or second invention, in which a detection unit detecting electric power is arranged at each of the nodes of the mesh-type power network, and the second electric power acquiring unit acquires electric power of the node from the detection unit.

In this way, since the detection unit is arranged at the node, the electric power is transmitted to the consumer that is the circulation destination through the detection unit, and a current value and a voltage value of the node can be measured. For this reason, the second electric power acquiring unit can acquire the electric power of each node on the power transmission route, and the state between nodes of the power transmission route can be estimated.

A power transmission route state detection device according to the seventh invention is the power transmission route state detection device according to the first or second invention, in which a detection unit detecting electric power by measuring a voltage is connected to a power distribution line drawn out from each of the nodes of the mesh-type power network, and the second electric power acquiring unit acquires electric power of each of the nodes from the detection unit.

Here, at a node through which the electric power on the power transmission route, a current value cannot be acquired, and only a voltage value can be acquired, but electric power can be calculated from a phase variation in the voltage. For this reason, the second electric power acquiring unit can acquire the electric power of each node on the power transmission route, and the state between nodes of the power transmission route can be estimated.

A power transmission route state detection device according to the eighth invention is the power transmission route state detection device according to the first invention, in which the power transmission route acquiring unit includes a connection state acquiring unit, a power transmission route extracting unit, a storage unit, an assumed power transmission loss calculating unit, and a power transmission route selecting unit. The connection state acquiring unit acquires a connection state between the nodes of the mesh-type power network. The power transmission route extracting unit extracts candidates of a power transmission route between the consumer that is the circulation source and the consumer that is the circulation destination on the basis of the acquired connection state. The storage unit stores an assumed inter-node transmission loss between the nodes. The assumed power transmission loss calculating unit calculates an assumed route power transmission loss for each of the extracted candidates of the power transmission route on the basis of the assumed inter-node power transmission loss. The power transmission route selecting unit selects the power transmission route on the basis of the assumed route power transmission loss.

Here, in a case in which electric power is circulated between consumers in the mesh-type power network, while a plurality of power transmission routes are present in accordance with connection states between nodes, a power transmission loss of each power transmission route is calculated, and a power transmission route having a smallest power transmission loss is selected, whereby the efficiency of the power transmission can be improved.

A power transmission route state detection system according to the ninth invention includes: the power transmission route state detection device according to any one of the first to fourth and eighth inventions; a first transmission unit; a detection unit; and a second transmission unit. The first transmission unit transmits electric power to be transmitted to the first electric power acquiring unit. The detection unit detects electric power of each of the nodes. The second transmission unit transmits the detected electric power to the second electric power acquiring unit.

In this way, the electric power transmitted by the circulation source and the electric power of a node to which the consumer that is the circulation destination is connected or a node in the middle of the power transmission route can be acquired, and the state of the power transmission route can be estimated on the basis of such electric power.

A power transmission route state detection system according to the tenth invention includes: the power transmission route state detection device according to any one of the fifth to seventh inventions; a first transmission unit; a detection unit; and a second transmission unit. The first transmission unit transmits electric power to be transmitted to the first electric power acquiring unit. The detection unit detects electric power of each of the nodes. The second transmission unit transmits the detected electric power to the second electric power acquiring unit.

In this way, the electric power transmitted by the circulation source and the electric power of a node to which the consumer that is the circulation destination is connected or a node in the middle of the power transmission route can be acquired, and the state of the power transmission route can be estimated on the basis of such electric power.

A power conversion device according to the eleventh invention is a power conversion device owned by a consumer that is connected to a node of a mesh-type power network and is a circulation source of electric power and includes a transmission unit that transmits information relating to electric power transmitted to a consumer, which is a circulation destination of the electric power, connected to another node of the mesh-type power network.

In this way, by including the transmission unit transmitting the amount of power transmission in the power conversion device, it can be detected whether or not power transmission is executed normally without the occurrence of a malfunction, power stealing, or the like in the power transmission route on the basis of the amount of transmitted power transmitted to the circulation destination.

A power transmission route state detection method according to the twelfth invention includes a power transmission route acquiring step, a first electric power acquiring step, a second electric power acquiring step, and a state estimating step. In the power transmission route acquiring step, a power transmission route for executing circulation of electric power between consumers connected to nodes of a mesh-type power network is acquired. In the first electric power acquiring step, electric power transmitted by a consumer that is a circulation source is acquired. In the second electric power acquiring step, electric power transmitted source to a consumer that is a circulation destination from the consumer that is the circulation is acquired. In the state estimating step, a state of the power transmission route acquired in the power transmission route acquiring step is estimated on the basis of the electric power acquired in the first electric power acquiring step and the electric power acquired in the second electric power acquiring step.

For this reason, for example, in a case in which the electric power received by the circulation destination is lower than the electric power transmitted by the circulation source, the occurrence of a malfunction, power stealing, or the like in the determined power transmission route can be detected.

A power transmission route state detection program according to the thirteenth invention causes a computer to execute a power transmission route state detection method including a power transmission route acquiring step, a first electric power acquiring step, a second electric power acquiring step, and a state estimating step. In the power transmission route acquiring step, a power transmission route for executing circulation of electric power between consumers connected to nodes of a mesh-type power network is acquired. In the first electric power acquiring step, electric power transmitted by a consumer that is a circulation source is acquired. In the second electric power acquiring step, electric power transmitted to a consumer that is a circulation destination from the consumer that is the circulation source is acquired. In the state estimating step, a state of the power transmission route acquired in the power transmission route acquiring step is estimated on the basis of the electric power acquired in the first electric power acquiring step and the electric power acquired in the second electric power acquiring step.

For this reason, for example, in a case in which the electric power received by the circulation destination is lower than the electric power transmitted by the circulation source, the occurrence of a malfunction, power stealing, or the like in the determined power transmission route can be detected.

### Advantageous Effects of Invention

According to the present invention, a power transmission route state detection device, a power transmission route state detection system, a power transmission route state detection method, a power transmission route state detection program, and a power conversion device capable of detecting a defect of a power transmission route or power stealing can be provided.

### BRIEF DESCRIPTION OF DRAWINGS

FIG. 1 is a block diagram illustrating connection relations among a power transmission route state detection system according to an embodiment of the present invention, consumers, and a power distribution system.

(a) to (d) of FIG. 2 are diagrams illustrating a connection state database of the power transmission route state detection system illustrated in FIG. 1.

FIG. 3 is a diagram illustrating power transmission route candidates extracted by the power transmission route state detection system illustrated in FIG. 1.

(a) to (d) of FIG. 4 are diagrams illustrating a power distribution line database stored by the power transmission route state detection system illustrated in FIG. 1.

FIG. 5 is a flowchart illustrating the operation of the power transmission route state detection system illustrated in FIG. 1.

FIG. 6 is a flowchart illustrating the operation of a power transmission route determination flow illustrated in FIG. 5.

FIG. 7 is a flowchart illustrating the operation of a state estimation flow illustrated in FIG. 5.

FIG. 8 is a block diagram illustrating connection relations among a power transmission route state detection system according to a modified example of the embodiment of the present invention, consumers, and a power distribution system.

FIG. 9 is a block diagram illustrating connection relations among a power transmission route state detection system according to a modified example of the embodiment of the present invention, consumers, and a power distribution system.

### DESCRIPTION OF EMBODIMENTS

Hereinafter, a power transmission route state detection device, a power transmission route state detection system, a power transmission route state detection method, a power transmission route state detection program, and a power conditioning device according to embodiments of the present invention will be described with reference to the drawings.

A power transmission route state detection system 1 according to an embodiment of the present invention is a system that detects the state of a defect, power stealing, and the like in a power transmission route when power is circulated among consumers in a mesh-type power network 51.

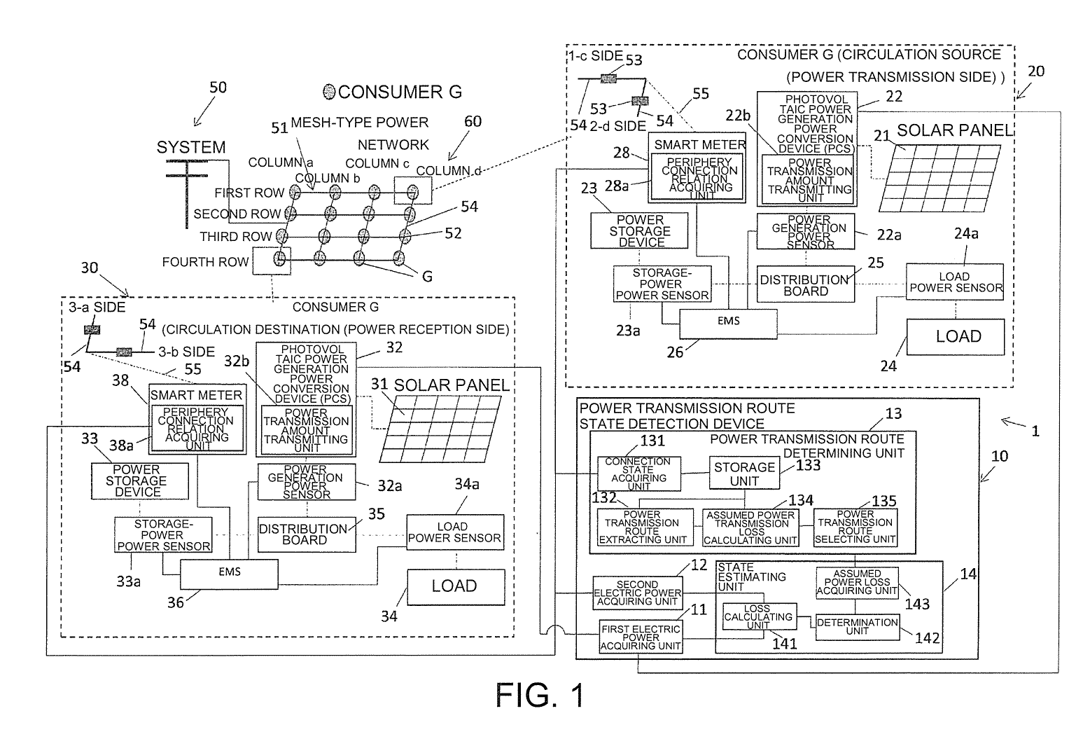

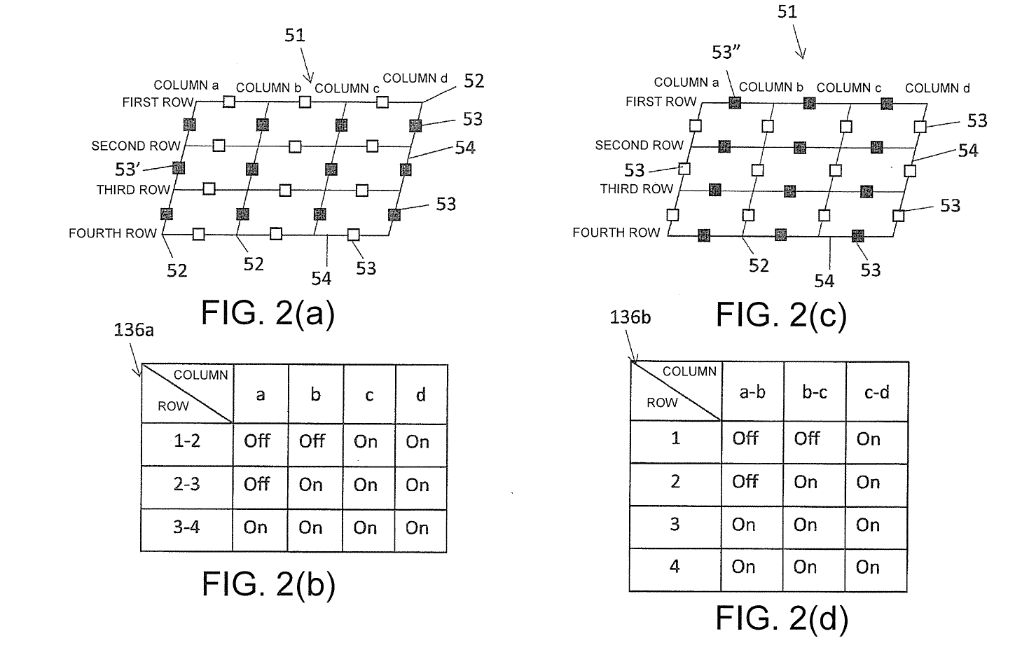

As illustrated in FIG. 1, the mesh-type power network 51 is connected to a power distribution system 50 from a power company. Power facilities of a consumer G are connected to a power distribution line 55 drawn out from each of a plurality of intersections (hereinafter referred to as nodes 52) of a power distribution line 54 forming this mesh-type power network 51. A consumer group 60 is configured by a plurality of consumers G connected to such a mesh-type power network 51.

In FIG. 1, the power configuration of a consumer G20 is illustrated as a power circulation source, and the power configuration of a consumer G30 is illustrated as a power circulation destination. The other consumers G have configurations similar to those of the consumers G20 and G30.

Here, the consumer G20 appearing in the following description includes a power generation apparatus (solar panel 21) and a storage battery (power storage device 23) and can buy electric power from the outside when the electric power is insufficient and sell electric power to the outside when surplus electric power is generated.

The consumer G30, similar to the consumer G20, includes a power generation apparatus (solar panel 31) and a storage battery (power storage device 33).

Here, a consumer is, for example, an individual, a corporation, an organization, or the like having a contract with a power company and using electric power supplied from the power company through a system 50 (see FIG. 1) and, for example, includes an ordinary home (a detached house or an apartment house), a company (an office, a factory, a facility, or the like), a local government, a government organization, and the like.

The “outside” described above includes a power company and the other consumers. In other words, examples of the “outside” to which the consumer G sells power include a power company, the other consumers G, and the like.

In the following embodiment, each of smart meters 28 and 38 (see FIG. 1) is a measuring device that is installed for each consumer, measures the amount of generated power, the amount of stored power, and the amount of power consumption, and transmits results of the measurements to a power company or the like using a communication function. By installing the smart meters 28 and 38, the power company can accurately ascertain the power status of each of the consumers G20 and G30 in real time and can automate a meter reading operation performed for every predetermined period.

Furthermore, in the following embodiment, for example, in a case in which a consumer is an ordinary home, loads 24 and 34 (see FIG. 1) are power consumption bodies such as an air conditioner, a refrigerator, a microwave oven, an IH cooking heater, a television set, and the like. In addition, for example, in a case in which a consumer is a company (a factory or the like), loads are power consumption bodies such as various facilities, air conditioning equipment, and the like installed in a factory.

Furthermore, in the following embodiment, each of energy management systems (EMSs) 26 and 36 (see FIG. 1) is a system that is installed for each consumer and is installed to reduce the amount of power consumption of each consumer.

### Embodiment

### <Configuration>

### (Overview of Power Transmission Route State Detection System 1)

The power transmission route state detection system 1 according to an embodiment of the present invention, when a power circulation source is the consumer G20 and a power circulation destination is the consumer G30, includes: a power transmission route state detection device 10; periphery connection relation acquiring units 28a and 38a; a power transmission amount transmitting unit 22b; and a smart meter 38.

Each of the periphery connection relation acquiring units 28a and 38a acquires a connection relation of switches 53 of the periphery of a node 52 to which the switches are connected and transmits the acquired connection relation to the power transmission route state detection device 10. While only the configurations of two consumers G20 and G30 are illustrated in FIG. 1, any other consumer has a configuration similar thereto, a connection relation of switches 53 in the periphery of a node 52 to which the switches are connected is acquired by a periphery connection relation acquiring unit, and the acquired connection relation is transmitted to the power transmission route state detection device 10. The periphery connection relation acquiring units 28a and 38a are respectively disposed inside the smart meters 28 and 38 of the consumers G20 and G30. While the switches 53 will be described later in detail, each of the switches 53 is arranged at a power distribution line 54 between nodes 52 and executes on/off of electrical connection between the nodes 52.

The consumer G20 is connected to a node 52 positioned in a first row and a column d of the mesh-type power network 51 illustrated in FIG. 1, and thus there are only two switches 53 in the periphery thereof. However, three switches 53 are present in the periphery of a node 52 positioned in the first row and a column c, and four switches 53 are present in the periphery of a node 52 positioned in the second row and the column c.

The power transmission amount transmitting unit 22b transmits the amount of transmitted power transmitted from the consumer G20 that is a circulation source to the consumer G30 that is the circulation destination to the power transmission route state detection device 10. The power transmission amount transmitting unit 22b is disposed in a photovoltaic power generation power conversion device (PCS) 22 of the consumer G20. The PCS 22 converts electric power generated by a solar panel 21 to be described later from a DC current to an AC current, and the converted electric power is used by the load 24 or is sold to the outside. In addition, the PCS 22 converts a voltage of the electric power generated by the solar panel 21, and the electric power of which the voltage is converted is accumulated in the power storage device 33.

The power transmission amount transmitting unit 22b is disposed in the PCS 22, and thus can transmit electric power that is generated by the solar panel 21 and is to be circulated to another consumer G30 to the power transmission route state detection device 10. Although electric power generated by the solar panel 21 can be sold, electric power collected once in the power storage device 23 cannot be sold, and accordingly, the power transmission amount transmitting unit 22b may be disposed in the PCS 22.

The smart meter 38 measures the electric power that is actually received by the consumer G30 that is the circulation destination and transmits a result of the measurement to the power transmission route state detection device 10.

In addition, since there are cases in which the consumer G30 becomes a circulation source, a power transmission amount transmitting unit 32b is also disposed in a photovoltaic power generation power conversion device (PCS) 32 of the consumer G30.

Next, the configuration of the power devices of the consumer G will be described, and the configuration of the power transmission route state detection device 10 according to this embodiment will be described in detail later.

### (Consumer)

The consumer G20, as illustrated in FIG. 1, includes: a solar panel (power generation apparatus) 21; a photovoltaic power generation power conversion device (PCS) 22; a power generation power sensor 22a; a power storage device (storage battery) 23; a storage-power power sensor 23a; a load 24; a load power sensor 24a; a distribution board 25; an energy management system (EMS) 26; and a smart meter 28. Solid lines connecting the components inside the consumer G illustrated in FIG. 1 represent the flow of information such as data, and dashed lines represent the flow of electricity. In addition, power distribution lines 54 are disposed outside the consumer G and are denoted by solid lines.

The solar panel (power generation apparatus) 21 is an apparatus that generates electricity using a photo electromotive force effect using light energy of sunlight and is installed on a roof or the like of the consumer G20. The amount of power generation in the solar panel 21 can be predicted on the basis of information relating to hours of sunlight of the weather forecast.

The photovoltaic power generation power conversion device (power conditioning system (PCS)) 22, as illustrated in FIG. 1, is connected to the solar panel 21 and converts a DC current generated in the solar panel 21 into an AC current.

The power generation power sensor 22a, as illustrated in FIG. 1, is connected to the photovoltaic power generation power conversion device 22 and measures electric power generated by the solar panel 21. Then, the power generation power sensor 22a transmits a result of the measurement (the amount of generated power) to the EMS 26.

The power storage device (storage battery) 23 is disposed for temporarily storing surplus electric power that has left unconsumed by the load 24 among electric power generated by the solar panel 21. In this way, by storing remaining electric power in the power storage device 23 also in a case in which the amount of consumed power of the load 24 is small in a time period of a daytime in which electric power is generated by the solar panel 21, wastefulness of disposing of the generated electric power can be avoided.

The storage-power power sensor 23a, as illustrated in FIG. 1, is connected to the power storage device 23 and measures the electric power stored by the power storage device 23. Then, the storage-power power sensor 23a transmits a result of the measurement (the amount of stored electric power) to the EMS 26.

The load 24, as described above, is a power consumption body such as electric home appliance such as an air conditioner or a refrigerator in an ordinary home or facilities or air conditioning equipment in a factory or the like and consumes electric power supplied from a power source 110 of a power company 100, electric power generated by the solar panel 21, and electric power stored by the power storage device 23.

The load power sensor 24a, as illustrated in FIG. 1, is connected to the load 24 and measures the electric power consumed by the load 24. Then, the load power sensor 24a transmits a result of the measurement (the amount of consumed electric power) to the EMS 26.

The distribution board 25, as illustrated in FIG. 1, is connected to the power generation power sensor 22a, the storage-power power sensor 23a, the load power sensor 24a, and the smart meter 28. The distribution board 25 supplies the electric power generated by the solar panel 21, the electric power stored by the power storage device 23, or electric power purchased from the system 50 to the load 24.

In addition, the distribution board 25 supplies surplus electric power to the system 50 through the smart meter 28. In this way, the consumer G20 can sell the surplus electric power to a power company or any other consumer G.

The energy management system (EMS) 26 is an energy management system disposed for reducing the amount of electric power consumed by the consumer G20 as described above and is connected to the power generation power sensor 22a, the storage-power power sensor 23a, and the load power sensor 24a as illustrated in FIG. 1. In addition, the EMS 26 efficiently supplies the electric power generated by the solar panel 21 and the amount of power stored in the power storage device 23 to the load 24 by using detection results received from the sensors 22a, 23a, and 24a. In this way, the consumption amount of electric power supplied from the system 50 is suppressed, and the power cost of the consumer G20 can be effectively reduced.

The smart meter 28, as described above, measures the amount of electric power generated by the solar panel 21 owned by the consumer G20, the amount of stored power of the power storage device 23, and the power consumption of the load 24. The smart meter 28, as illustrated in FIG. 1, is connected to the sensors 22a, 23a, and 24a through the distribution board 25. In addition, the smart meter 28 has a communication function and transmits information relating to the amount of generated power, the amount of stored power, and the amount of consumed power of the consumer G20 to the power company.

The consumer G30 has a configuration similar to that of the consumer G20.

The consumer G30, as illustrated in FIG. 1, includes: a solar panel (power generation apparatus) 31; a photovoltaic power generation power conversion device (PCS) 32; a power generation power sensor 32a; a power storage device (storage battery) 33; a storage-power power sensor 33a; a load 34; a load power sensor 34a; a distribution board 35; an energy management system (EMS) 36; and a smart meter 38.

### (Power Transmission Route State Detection Device)

The power transmission route state detection device 10 according to this embodiment includes: a first electric power acquiring unit 11; a second electric power acquiring unit 12; a power transmission route determining unit 13; and a state estimating unit 14.

In this embodiment, while a case in which electric power is supplied from the consumer G20 to the consumer G30 will be described as an example, an opposite case may be employed.

### (First Electric Power Acquiring Unit 11)

The first electric power acquiring unit 11 receives information of electric power transmitted from the consumer G20 that is a power circulation source to the consumer G30 that is a circulation destination from the power transmission amount transmitting unit 22b of the consumer G30. The communication between the first electric power acquiring unit 11 and the power transmission amount transmitting unit 22b may be executed in a wired or wireless manner and may be executed through the Internet or the like.

In addition, in a case in which another consumer G becomes a power circulation source, the first electric power acquiring unit 11 receives information of electric power transmitted from the power transmission amount transmitting unit of the consumer G.

### (Second Electric Power Acquiring Unit 12)

The second electric power acquiring unit 12 receives information of electric power received by the consumer G30 that is a power circulation destination from the smart meter 38. The communication between the second electric power acquiring unit 12 and the smart meter 38 may be executed in a wired or wireless manner and may be executed through the Internet or the like.

In addition, in a case in which another consumer G becomes a power circulation destination, the second electric power acquiring unit 12 receives information of electric power received from the smart meter of the consumer G.

### (Power Transmission Route Determining Unit 13)

The power transmission route determining unit 13 determines a power transmission route through which electric power is transmitted from the consumer G20 that is a circulation source to the consumer G30 that is a circulation destination.

The power transmission route determining unit 13 includes: a connection state acquiring unit 131, a power transmission route extracting unit 132; a storage unit 133; an assumed power transmission loss calculating unit 134; and a power transmission route selecting unit 135.

From each consumer G, the connection state acquiring unit 131 acquires information relating to switches 53 present in the periphery of a node 52 to which the consumer G is connected and acquires connection states of the switches 53 in the mesh-type power network 51. Then, the connection state acquiring unit 131 records the connection states of the switches 53 in connection relation databases 136a and 136b stored by the storage unit 133.

(a) to (d) of FIG. 2 are diagrams illustrating the connection states of switches 53 in the mesh-type power network 51. FIGS. 2(b) and (d) respectively illustrate the connection relation databases 136a and 136b of the mesh-type power network 51 acquired by the connection state acquiring unit 131. The connection relation database 136a illustrated in FIG. 2(b) illustrates the states of switches 53, to which a color is applied, illustrated in FIG. 2(a). For example, a switch 53 positioned in a column a between first and second rows in FIG. 2(b) is in the Off state, and this switch 53 is illustrated as a switch 53′ in FIG. 2(a). The connection relation database 136b illustrated in FIG. 2(d) illustrates the states of switches 53, to which a color is applied, illustrated in FIG. 2(c). For example, a switch 53 positioned in the first row between columns a and b is in the Off state, and this switch 53 is represented as a switch 53″ in FIG. 2(c).

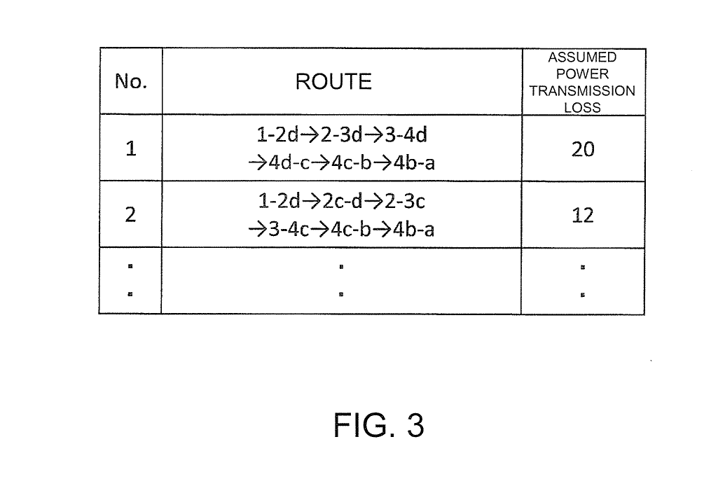

The power transmission route extracting unit 132 extracts a power transmission route through which electric power can be transmitted from the consumer G20 (a node 52 positioned in the first row and the column d) that is the circulation source to the consumer G30 (a node 52 positioned in the fourth row and the column a) that is the circulation destination from the states of switches 53 in the mesh-type power network 51 acquired by the connection state acquiring unit 131. In the connection states illustrated in FIGS. 2(a) to (d), since a power distribution line 54 in which the switch 53 is in the Off state cannot be selected as a power transmission route, the power transmission route extracting unit 132 extracts a plurality of power transmission route candidates as illustrated in FIG. 3. For example, among the power transmission route candidates, in a power transmission route 1, from a node 52 positioned in the first row and the column d to which the consumer G20 is connected, movement is made from the first row to the second row through the column d, movement is made from the second row to the third row through the column d, movement is made from the third row to the fourth row through the column d, movement is made from the column d to the column c through the fourth row, movement is made from the column c to the column b through the fourth row, and movement is made from the column b to the column a through the fourth row, whereby the node 52 positioned in the fourth row and the column a to which the consumer G30 is connected is reached. In this way, the power transmission route extracting unit 132 extracts a plurality of power transmission route candidates that can reach from the consumer G that is a circulation source to the consumer G that is the circulation destination on the basis of the states of the switches 53.

The storage unit 133 stores power transmission line databases 137a and 137b of the power distribution line 54 between nodes 52 together with the connection relation databases 136a and 136b. FIGS. 4(b) and (d) are diagrams illustrating the power transmission line databases 137a and 137b stored in the storage unit 133. FIG. 4(a) is a diagram illustrating the power transmission line database 137a illustrated in FIG. 4(b). The power transmission line database 137a illustrated in FIG. 4(b) illustrates information of power distribution lines 54 of the thick lines illustrated in FIG. 4(a). For example, information relating to a power distribution line 54′ between the first row and the column a and the second row and the column a illustrated in FIG. 4(a) is represented as the column a between the first and second rows to have a length of 1 km, resistance of 0.3 Ω/km, and a thickness of 60 mm² in FIG. 4(b). In addition, the power transmission line database 137b illustrated in FIG. 4(d) represents information of power distribution lines of thick lines illustrated in FIG. 4(c). For example, information relating to a power distribution line 54″ between the fourth row and the column c and the fourth row and the column d illustrated in FIG. 4(c) is represented as the fourth row between the columns c and d to have a length of 1.9 km, resistance of 0.2 Ω/km, and a thickness of 100 mm² in FIG. 4(d).

The assumed power transmission loss calculating unit 134 calculates an assumed power loss for each of power transmission route candidates extracted by the power transmission route extracting unit 132 on the basis of the power transmission line databases 137a and 137b.

In addition, the assumed power transmission loss amount is estimated using following power transmission line loss estimating equations (Equation 1) (Equation 2) by using the information stored in the power transmission line databases 137a and 137b.

Assumed power transmission loss amount (P)=current amount (I2)×wire resistance (R) (Equation 1)

Wire resistance (R)=resistance ρ(Ω/km) for each power transmission line×length L (km) of each power transmission line (Equation 2)

In this way, for example, as illustrated in FIG. 3, the assumed power transmission loss for each power transmission route candidate is calculated.

The power transmission route selecting unit 135 selects one power transmission route among the plurality of power transmission routes extracted by the power transmission route extracting unit 132 on the basis of the assumed power transmission losses calculated by the assumed power transmission loss calculating unit 134. More specifically, the power transmission route selecting unit 135 selects a power transmission route candidate having a smallest assumed power transmission loss as a power transmission route.

### (State Estimating Unit)

The state estimating unit 14 includes a loss calculating unit 141, a determination unit 142, and an assumed power loss acquiring unit 143.

The loss calculating unit 141 calculates an actual power transmission loss amount from electric power transmitted by the consumer G20, which is the circulation source, acquired by the first electric power acquiring unit 11 and electric power actually received by the consumer G30, which is the circulation destination, acquired by the second electric power acquiring unit 12.

The assumed power loss acquiring unit 143 acquires an assumed power transmission loss amount in the power transmission route calculated by the assumed power transmission loss calculating unit 134.

The determination unit 142 compares an actual power transmission loss amount with the assumed transmission power loss amount acquired by the assumed power loss acquiring unit 143 and determines whether or not power transmission is normally executed. For example, in a case in which an abnormality is determined, it may be considered that a malfunction or power stealing occurs in one of the power distribution lines 54 and the switches 53 in the power transmission route.

### <Operation>

Hereinafter, the operation of the power transmission route state detection system according to an embodiment of the present invention and one example of a power transmission route state estimation method according to the present invention will be described.

### (Whole Flow)

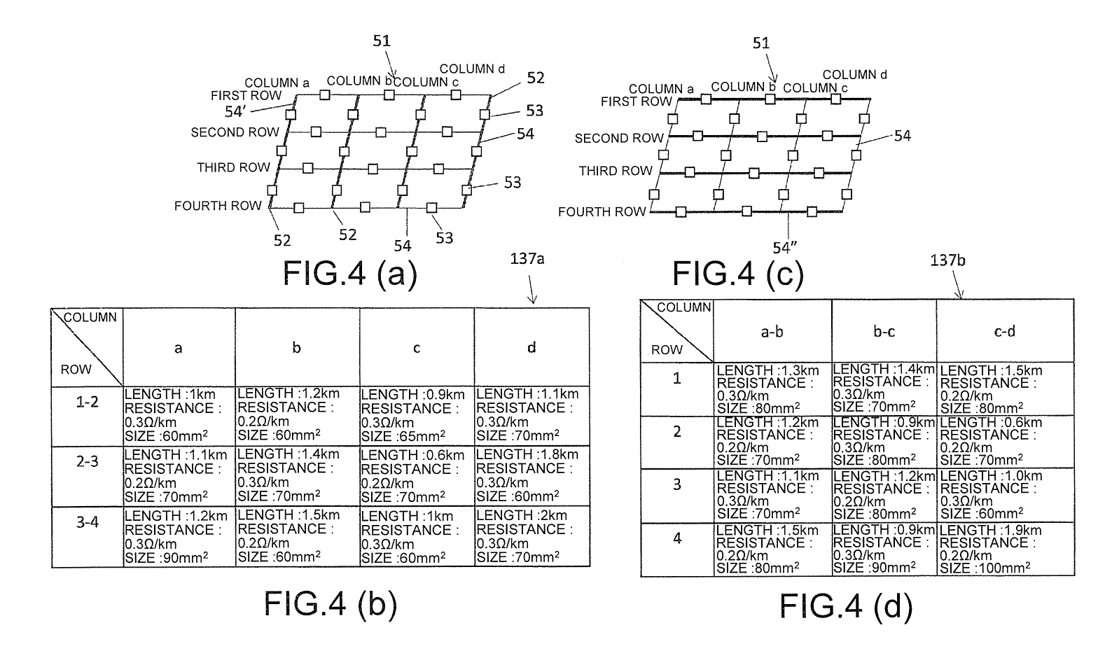

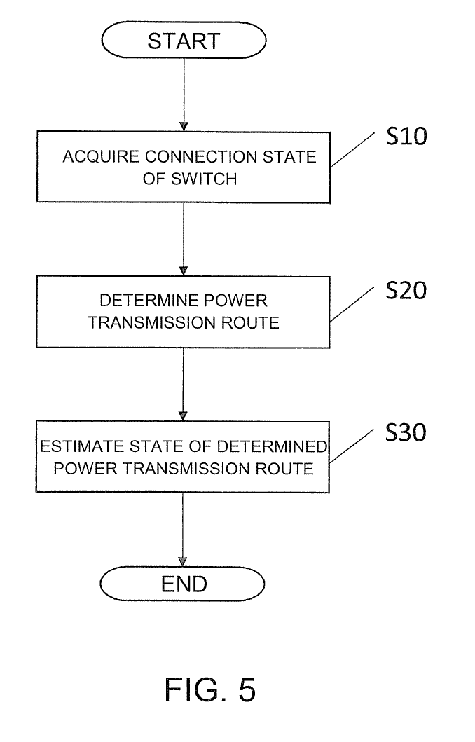

FIG. 5 is a flowchart illustrating the operation of the power transmission route state estimation method according to an embodiment of the present invention.

Here, in this embodiment, the consumer G20 that is a power circulation source and the consumer G30 that is a circulation destination are assumed to be selected in advance on the basis of the electric power that can be supplied and a demand amount for each consumer. Then, information relating to consumers that are the circulation source and the circulation destination is transmitted to the power transmission route extracting unit 132 from a device that automatically selects the circulation source and the circulation destination or a device to which the circulation source and the circulation destination are input by an operator or the like.

First, in Step S10, the connection state acquiring unit 131 acquires connection relations between nodes 52 (it can be regarded as between smart meters) of the mesh-type power network 51. In more details, from smart meters of all the consumers connected to the mesh-type power network 51, connection states of switches 53 in the periphery thereof are acquired and are recorded in the connection relation databases 136a and 136b (see FIG. 2). In addition, the connection state acquiring unit 131 may acquire only connection states from the consumer G that is the circulation source to the consumer G that is the circulation destination. In such a case, for example, in a case in which the circulation source is the consumer positioned in the row c and the second row and the circulation destination is a consumer positioned in the column b and the third row, the states of switches 53 in the second row between the column c and the column b, between the second row and the third row in the column b, between the second row and the third row in the column c, and between the column c and the column b in the third row are acquired.

Next, in Step S20, the power transmission route determining unit 13 determines a power transmission route in accordance with a power transmission route determination flow to be described later on the basis of the connection state from the circulation source to the circulation destination stored in the connection relation databases 136a and 136b and the information of power distribution lines 54 stored in the power transmission line databases 137a and 137b. Step S20 corresponds to one example of a power transmission route acquisition step.

Next, in Step S30, the state estimating unit 14 estimates the state (an abnormality, power stealing, or the like) of the determined power transmission route on the basis of the assumed power transmission loss amount in the power transmission route determined in accordance with a state estimating flow to be described later and an actual power transmission loss amount calculated from the actually circulated electric power.

### (Power Transmission Route Determination Flow)

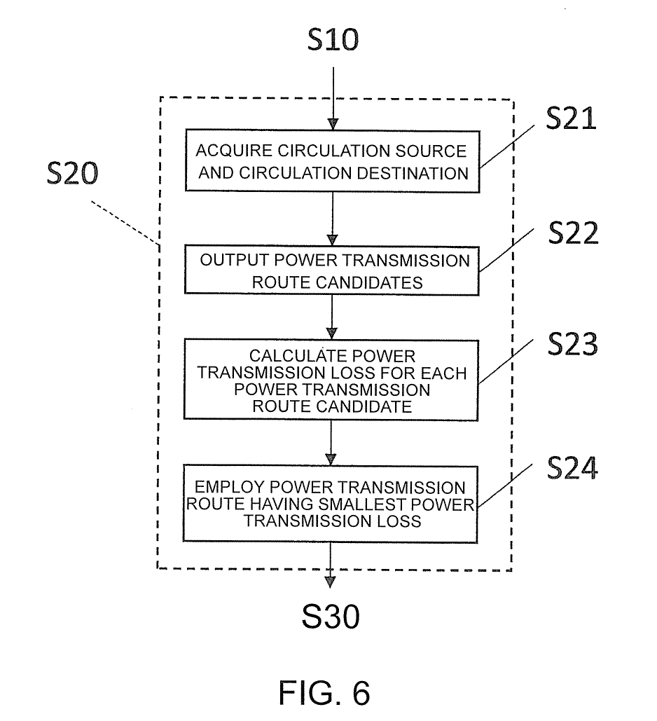

FIG. 6 is a diagram illustrating the power transmission route determination flow and is a diagram illustrating Step S20 illustrated in FIG. 5 in detail.

After Step S10, in Step S21, the power transmission route extracting unit 132 acquires information of the consumer G20 that is the power circulation source and the consumer G30 that is the circulation destination that are set in advance and are transmitted as described above.

Next, in Step S22, the power transmission route extracting unit 132 extracts power transmission route candidates (see FIG. 3) through which electric power can be transmitted from the consumer G20 that is the circulation source to the consumer G30 that is the circulation destination on the basis of the connection relation databases 136a and 136b.

Next, in Step S23, the assumed power transmission loss calculating unit 134 calculates a power loss assumed for each power transmission route candidate extracted by the power transmission route extracting unit 132 on the basis of the power transmission line databases 137a and 137b.

Next, in Step S24, the power transmission route selecting unit 135 selects a power transmission route candidate having a smallest power transmission loss among the plurality of power transmission route candidates extracted by the power transmission route extracting unit 132 on the basis of the assumed power transmission losses calculated by the assumed power transmission loss calculating unit 134 as a power transmission route.

### (State Estimating Step)

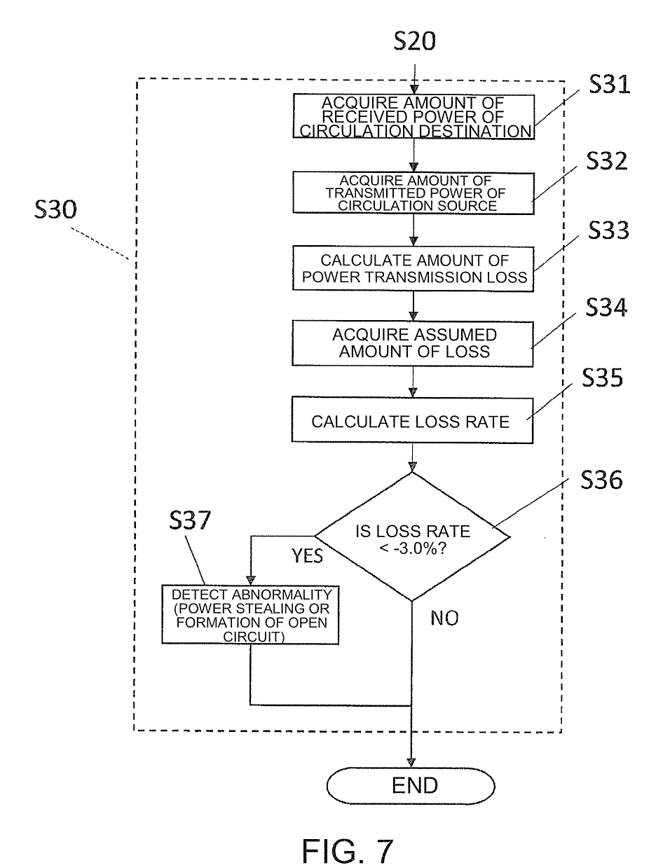

FIG. 7 is a diagram illustrating the state estimating flow and is a diagram illustrating Step S30 illustrated in FIG. 5 in detail.

After Step S24 (Step S20), in Step S31, the second electric power acquiring unit 12 receives information of electric power received by the consumer G30 that is the power circulation destination from the smart meter 38. Step S23 corresponds to one example of a second electric power acquiring step.

Next, in Step S32, the first electric power acquiring unit 11 receives the information of electric power transmitted by the consumer G20 that is the power circulation source to the consumer G30 that is the circulation destination from the power transmission amount transmitting unit 22b of the consumer G30. Step S32 corresponds to one example of a first electric power acquiring step.

Next, in Step S33, the loss calculating unit 141 calculates a difference between the electric power transmitted by the consumer G20, which is the circulation source, acquired by the first electric power acquiring unit 11 and the electric power that is actually received by the consumer G30, which is the circulation destination, acquired by the second electric power acquiring unit 12 and calculates an actual power transmission loss amount.

Next, in Step S34, the determination unit 142 acquires the assumed transmission power loss amount in the power transmission route that is calculated and determined by the assumed power transmission loss calculating unit 134 from the power transmission route determining unit 13.

Next, in Step S35, the determination unit 142 calculates a loss rate. The loss rate is calculated using the following equation (Equation 3).

Loss rate=((assumed power transmission loss amount−actual power transmission loss amount)/assumed power transmission loss amount)×100(%). (Equation 3)

Next, in Step S36, the determination unit 142 determines whether or not the loss rate is lower than −3%.

In Step S36, in a case in which the loss rate is lower than −3%, the actual power transmission loss amount is larger than the assumed power transmission loss amount, and the determination unit 142 detects an abnormality in Step S37.

On the other hand, in Step S36, in a case in which the loss rate is −3% or more, the determination unit 142 determines that the actual power transmission loss amount is within an allowed range of the assumed loss amount and is normal. These Steps S33 to S36 correspond to a state estimating step.

According to the operations described above, a power transmission route between the consumer that is the power circulation source and the consumer that is the circulation destination in the mesh-type power network 51 is determined, and the state (a malfunction, power stealing, or the like) of the determined power transmission route can be estimated.

### Other Embodiments

As above, while one embodiment of the present invention has been described, the present invention is not limited to the embodiment described above, and various changes can be made within a range not departing from the concept of the present invention.

### (A)

In the embodiment described above, as the power transmission route state estimation method according to the present invention, while an example, in which, the power transmission route state estimation method is executed in accordance with the flowcharts illustrated in FIGS. 5, 6, and 7 has been described, the present invention is not limited thereto.

For example, the present invention may be realized as a power transmission route state estimation method program causing a computer to execute the power transmission route state estimation method in accordance with the flowcharts illustrated in FIGS. 5, 6, and 7.

In addition, one use form of the power transmission route state estimation program may be in the form of being recorded in a computer-readable recording medium such as a ROM and operating in corporation with a computer.

In addition, another use form of the power transmission route state estimation program may be in the form of being transmitted in a transmission medium such as the Internet or a transmission medium such as light, electric waves, sonic waves, or the like, being read by a computer, and operating in cooperation with the computer.

Furthermore, the computer described above is not limited to hardware such as a CPU but may include firmware, an OS, or peripheral devices.

In addition, as described above, the power transmission route state estimation may be realized by either software or hardware.

Furthermore, furthermore, the power transmission route state detection device 10 may be a virtual server in a cloud computing system, and a power transmission route state estimation program may be executed by the virtual server.

### (B)

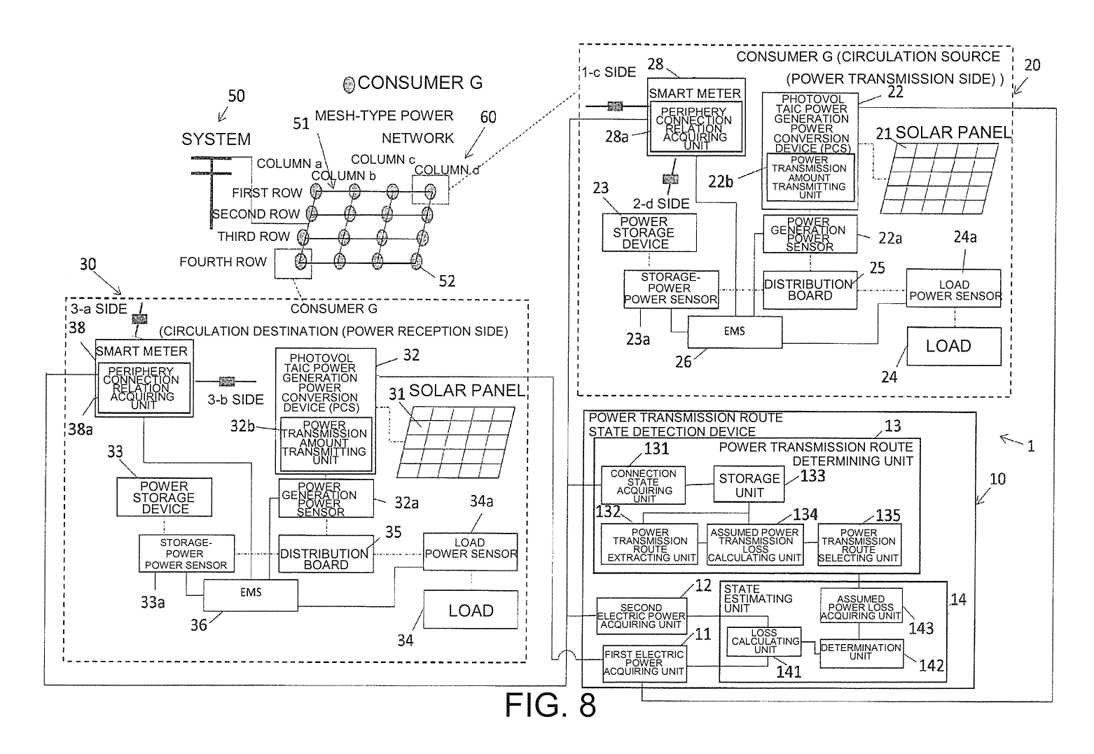

In the power transmission route state detection system 1 according to the embodiment described above, the smart meters 28 and 38 are connected to the power distribution line 55 drawn out from the node 52 intersecting with the power distribution line 54 of the mesh-type power network 51, as illustrated in FIG. 8, the smart meters 28 and 38 may be arranged at the nodes 52 intersecting with the power distribution line 54.

By arranging the smart meter of the consumer G connected to the mesh-type power network 51 at each node 52, the electric power can be acquired for each node 52. For this reason, the state of the power distribution line 54 between every nodes 52 (between smart meters) can be estimated.

In other words, in the embodiment described above, the smart meter of the consumer G is connected to the power distribution line 55 drawn out from the node 52. For this reason, at a node 52 through which electric power passes other than the circulation source and the circulation destination, a current cannot be acquired, and electric power cannot be detected. To the contrary, in the configuration illustrated in FIG. 8, since smart meters are arranged at the nodes 52, a current can be measured also at the node 52 through which electric power passes, and electric power can be detected.

For this reason, the state can be estimated for each power distribution line 54 between nodes 52, and a position (the power distribution line 54) at which a malfunction of the power transmission route or power stealing occurs can be estimated.

In the example of the power transmission route 1 illustrated in FIG. 3, the states of the power distribution line 54 between the first and second rows in the column d, the power distribution line 54 between the second and third rows in the column d, the power distribution line 54 between the third and fourth rows in the column d, the power distribution line 54 between the columns d and c in the fourth row, the power distribution line 54 between the columns c and b in the fourth row, and the power distribution line 54 between the columns b and a in the fourth row can be detected.

In this case, the first electric power acquiring unit 11 receives electric power from the smart meters of all the consumers G connected to the nodes 52 on the power transmission route. Then, the assumed power transmission loss calculating unit 134 calculates an assumed power transmission loss amount of each power distribution line 54 until the reach at the consumer G. Then, for example, when the state of the power distribution line 54 between the first and second rows in the column d from the consumer G20 is determined, the determination unit 142 determines the state of the power distribution line 54 between the second and third rows in the column d and sequentially determines the state up to the consumer G20 for each power distribution line 54. In addition, for example, when the state of the power distribution line 54 between the first and second rows in the column d is determined, Step S30 illustrated in FIG. 7 may be executed using the electric power from the smart meter positioned in the column d and the second row as the electric power of the circulation destination. Furthermore, when the state of the power distribution line 54 between the second and third rows in the column d is determined, Step S30 illustrated in FIG. 7 may be executed using the electric power from the smart meter positioned in the column d and the second row as the electric power of the circulation source and using the electric power from the smart meter positioned in the column d and the third row as the electric power of the circulation destination.

### (C)

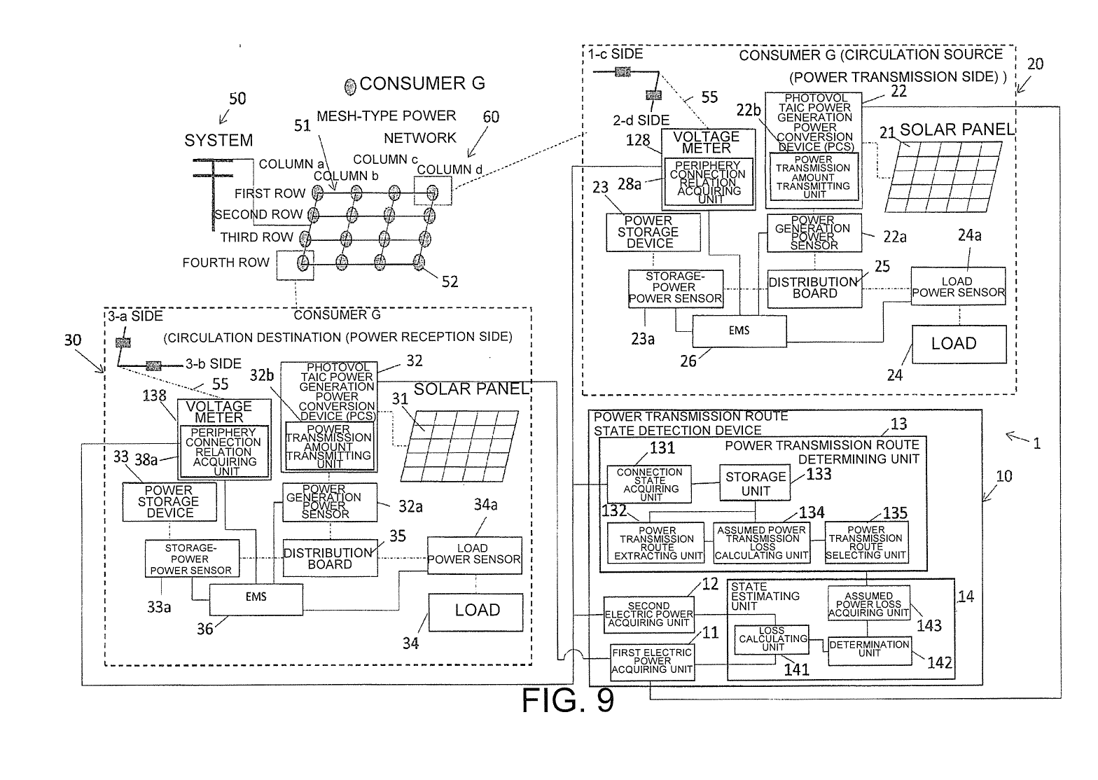

In addition, as illustrated in FIG. 9, the electric power of each node 52 may be detected by arranging voltage meters 128 and 138 instead of the smart meters 28 and 38. Each of these voltage meters 128 and 138 can measure a phase of a voltage and detect electric power from the phase. For this reason, electric power can be calculated without measuring a current.

By using this electric power, similar to (B) described above, the state of each power distribution line 54 between the nodes 52 on the power transmission route can be estimated.

### (D)

In the embodiment described above, although the power transmission route determining unit 13 (one example of a power transmission route acquiring unit) of the power transmission route state detection device 10 is determined, the power transmission route state detection device 10 may not determine a power transmission route. In other words, the power transmission route state detection device 10 may acquire a power transmission route determined on the outside and detect the state of the power transmission route.

### (E)

In the embodiment described above, although the loss calculating unit 141 and the assumed power loss acquiring unit 143 are disposed in the state estimating unit 14, the loss calculating unit 141 and the assumed power loss acquiring unit 143 may not be disposed in the state estimating unit 14.

### (F)

In the embodiment described above, although the power facilities of the consumer G have been described as being connected to the power distribution lines 55 drawn out from intersections of the power distribution lines 54, the consumers may not be connected to all the intersections, and the connection portions are not limited to the intersections.

### (G)

In the embodiment described above, although the power transmission amount transmitting units 22b and 32b are disposed in the PCS's 32 and 33, the portions are not limited thereto, and the power transmission amount transmitting units 22b and 32b may be disposed in the EMS's 36 or the smart meters 28 and 38.

### (H)

In the embodiment described above, although the consumers G20 and G30 and the other consumer G have been described to include the power storage devices 23 and 33 and the solar panels 21 and 31, only one thereof may be included, or both thereof may not be included.

### (I)

In the embodiment described above, while the solar panels 21 and 31 (photovoltaic power generation apparatuses) have been described to be used as power generation apparatuses owned by the consumers G20 and G30, the power generation apparatuses are not limited thereto.

For example, as power generation apparatuses owned by a plurality of consumers, other power generation apparatuses such as wind power generation apparatuses, geothermal power generation apparatuses, or diesel power generation apparatuses may be used.

### INDUSTRIAL APPLICABILITY

The power transmission route state detection device, the power transmission route state detection system, the power transmission route state detection method, the power transmission route state detection program, and the power conversion device according to the present invention have an effect of being capable of detecting a malfunction of an electric route or power stealing and can be broadly applied to a consumer group.

### REFERENCE SIGNS LIST

1 Power transmission route state detection system
10 Power transmission route state detection device
11 First electric power amount acquiring unit
12 Second electric power amount acquiring unit
13 Power transmission route determining unit (one example of a power transmission route acquiring unit)
14 State estimating unit
21 Solar panel
22 Photovoltaic power generation power conversion device (one example of a power conversion device)
22a Power generation power sensor
22b Power transmission amount transmitting unit
23 Power storage device
23a Storage-power power sensor
24 Load
24a Load power sensor
25 Distribution board
26 EMS
28 Smart meter
28a Periphery connection relation acquiring unit
31 Solar panel
32a Power generation power sensor
32b Power transmission amount transmitting unit
33 Power storage device
33a Storage-power power sensor
34 Load
34a Load power sensor
35 Distribution board
36 EMS
38 Smart meter (one example of a detection unit; one example of a second transmission unit)
38a Periphery connection relation acquiring unit
50 Power distribution system
51 Mesh-type power network
52 Node
53 Switch
53′ Switch
53″ Switch
54 Power distribution line
54′ Power distribution line
54″ Power distribution line
60 Consumer group
100 Power company
110 Power source
128 Voltage meter (one example of a detection unit)
131 Connection state acquiring unit
132 Power transmission route extracting unit
133 Storage unit
134 Assumed power transmission loss calculating unit
135 Power transmission route selecting unit
136a Connection relation database
136b Connection relation database
137a Power transmission line database
137b Power transmission line database
138 Voltage meter
141 Loss calculating unit
142 Determination unit
143 Assumed power loss acquiring unit
G20 Consumer
G30 Consumer

1. A power transmission route state detection device comprising:
a power transmission route acquiring unit that acquires a power transmission route for executing circulation of electric power between consumers connected to nodes of a mesh-type power network;
a first electric power acquiring unit that acquires electric power transmitted by a consumer that is a circulation source;
a second electric power acquiring unit that acquires electric power transmitted to a consumer that is a circulation destination from the consumer that is the circulation source; and
a state estimating unit that estimates a state of the power transmission route acquired by the power transmission route acquiring unit on the basis of the electric power acquired by the first electric power acquiring unit and the electric power acquired by the second electric power acquiring unit.

2. The power transmission route state detection device according to claim 1,
wherein the consumers are connected to nodes with which power distribution lines of the mesh-type power network intersect,
wherein one or more of the nodes through which electric power passes at the time of power transmission are disposed between a node to which the consumer that is the circulation source is connected and a node to which the consumer that is the circulation destination is connected on the power transmission route, and
wherein the second electric power acquiring unit acquires electric power of the node through which the electric power passes in addition to the node to which the consumer that is the circulation destination is connected.

3. The power transmission route state detection device according to claim 1, wherein the first electric power acquiring unit acquires the electric power transmitted by the consumer that is the circulation source from a power converting device owned by the consumer that is the circulation source.

4. The power transmission route state detection device according to claim 1, further comprising:
an assumed loss acquiring unit that acquires an assumed power loss between the node to which the consumer that is the circulation source is connected and the node to which the consumer that is the circulation destination is connected; and
a loss calculating unit that calculates an actual power loss from a difference between the electric power acquired by the first electric power acquiring unit and the electric power acquired by the second electric power acquiring unit,
wherein the state estimating unit includes a determination unit that determines whether or not the state of the power transmission route is normal by comparing the actual power loss calculated by the loss calculating unit with an assumed power loss amount acquired by the assumed power loss acquiring unit.

5. The power transmission route state detection device according to claim 1,
wherein a detection unit detecting electric power is connected to a power distribution line drawn out from each of the nodes of the mesh-type power network, and
wherein the second electric power acquiring unit acquires electric power of the node from the detection unit.

6. The power transmission route state detection device according to claim 1,
wherein a detection unit detecting electric power is arranged at each of the nodes of the mesh-type power network, and
wherein the second electric power acquiring unit acquires electric power of the node from the detection unit.

7. The power transmission route state detection device according to claim 1,
wherein a detection unit detecting electric power by measuring a voltage is connected to a power distribution line drawn out from each of the nodes of the mesh-type power network, and
wherein the second electric power acquiring unit acquires electric power of each of the nodes from the detection unit.

8. The power transmission route state detection device according to claim 1, wherein the power transmission route acquiring unit includes:
a connection state acquiring unit that acquires a connection state between the nodes of the mesh-type power network;
a power transmission route extracting unit that extracts candidates of a power transmission route between the consumer that is the circulation source and the consumer that is the circulation destination on the basis of the acquired connection state;
a storage unit that stores an assumed inter-node transmission loss between the nodes;
an assumed power transmission loss calculating unit that calculates an assumed route power transmission loss for each of the extracted candidates of the power transmission route on the basis of the assumed inter-node power transmission loss; and
a power transmission route selecting unit that selects the power transmission route on the basis of the assumed route power transmission loss.

9. A power transmission route state detection system comprising:
the power transmission route state detection device according to claim 1;
a first transmission unit that transmits electric power to be transmitted to the first electric power acquiring unit;
a detection unit that detects electric power of each of the nodes; and
a second transmission unit that transmits the detected electric power to the second electric power acquiring unit.

10. A power transmission route state detection system comprising:
the power transmission route state detection device according to any one of claim 5;
a first transmission unit that transmits electric power to be transmitted to the first electric power acquiring unit;
a detection unit that detects electric power of each of the nodes; and
a second transmission unit that transmits the detected electric power to the second electric power acquiring unit.

11. A power conversion device owned by a consumer that is connected to a node of a mesh-type power network and is a circulation source of electric power, the power conversion device comprising:
a transmission unit that transmits information relating to electric power transmitted to a consumer, which is a circulation destination of the electric power, connected to another node of the mesh-type power network.

12. A power transmission route state detection method comprising:
a power transmission route acquiring step of acquiring a power transmission route for executing circulation of electric power between consumers connected to nodes of a mesh-type power network;
a first electric power acquiring step of acquiring electric power transmitted by a consumer that is a circulation source;
a second electric power acquiring step of acquiring electric power transmitted to a consumer that is a circulation destination from the consumer that is the circulation source; and
a state estimating step of estimating a state of the power transmission route acquired in the power transmission route acquiring step on the basis of the electric power acquired in the first electric power acquiring step and the electric power acquired in the second electric power acquiring step.

13. A non-transitory recording medium, storing a power transmission route state detection program causing a computer to execute a power transmission route state detection method comprising:
a power transmission route acquiring step of acquiring a power transmission route for executing circulation of electric power between consumers connected to nodes of a mesh-type power network;
a first electric power acquiring step of acquiring electric power transmitted by a consumer that is a circulation source;
a second electric power acquiring step of acquiring electric power transmitted to a consumer that is a circulation destination from the consumer that is the circulation source; and
a state estimating step of estimating a state of the power transmission route acquired in power transmission route acquiring step on the basis of the electric power acquired in the first electric power acquiring step and the electric power acquired in the second electric power acquiring step.

14. The power transmission route state detection device according to claim 2, further comprising:
an assumed loss acquiring unit that acquires an assumed power loss between the node to which the consumer that is the circulation source is connected and the node to which the consumer that is the circulation destination is connected; and
a loss calculating unit that calculates an actual power loss from a difference between the electric power acquired by the first electric power acquiring unit and the electric power acquired by the second electric power acquiring unit,
wherein the state estimating unit includes a determination unit that determines whether or not the state of the power transmission route is normal by comparing the actual power loss calculated by the loss calculating unit with an assumed power loss amount acquired by the assumed power loss acquiring unit.

15. The power transmission route state detection device according to claim 2,
wherein a detection unit detecting electric power is arranged at each of the nodes of the mesh-type power network, and
wherein the second electric power acquiring unit acquires electric power of the node from the detection unit.

16. The power transmission route state detection device according to claim 2,
wherein a detection unit detecting electric power by measuring a voltage is connected to a power distribution line drawn out from each of the nodes of the mesh-type power network, and
wherein the second electric power acquiring unit acquires electric power of each of the nodes from the detection unit.
